(19) United States
(12) Patent Application Publication
(10) Pub. No.: US 2014/0178719 A1
(43) Pub. Date: Jun. 26, 2014

(54) IMMERSION TOLERANT ENERGY STORAGE SYSTEM

(71) Applicant: Magna Steyr, Auburn Hills, MI (US)

(72) Inventors: Robert Gordon Storc, Rochester Hills, MI (US); Jonas Bereisa, Bloomfield Hills, MI (US); David Edwin Barnhart, Clarkston, MI (US); Williams B. Suber, Birmingham, MI (US); James Edward Robertson, Rochester, MI (US); Kenneth Ratkovich, Bloomfield Hills, MI (US)

(73) Assignee: Magna Steyr, Auburn Hills, MI (US)

(21) Appl. No.: 14/096,249

(22) Filed: Dec. 4, 2013

Related U.S. Application Data
(60) Provisional application No. 61/732,977, filed on Dec. 4, 2012.

(51) Int. Cl. H01M 2/08; H01M 2/12; H01M 10/625

(52) U.S. Cl. CPC H01M 2/08; H01M 10/5016; H01M 2/1241
USPC 429/56; 429/120; 429/90; 429/53; 429/82

(57) ABSTRACT

The present disclosure relates to an immersion tolerant electrical energy storage system for use with electric vehicles. The energy storage system is equipped with a sealed battery unit and a sealed heat exchanger that cooperates to inhibit the intrusion of fluids and other contaminants into the system. The ability to limit intrusion of such fluids and contaminants provides improved service life for the batteries in the battery unit and components of the thermal control system.

### CROSS-REFERENCE TO RELATED APPLICATION

This application claims priority to and the benefit of U.S. Provisional Application No. 61/732,977 filed Dec. 4, 2012. The entire disclosure of the above-noted application is incorporated herein by reference.

### FIELD

The present disclosure relates generally to electric vehicles and, more particularly, to an immersion tolerant electrical energy storage system for use with electric vehicles.

### BACKGROUND

This section provides background information related to the present disclosure which is not necessarily prior art.

Electric vehicles offer the promise of powered transportation through the use of electric motors while producing few or no emissions. Some electric vehicles are powered by electric motor(s) only and rely solely on the energy stored in an on-board battery pack. Other electric vehicles are hybrids and include an internal combustion engine which may, for example, be used to assist the electric motor(s) in driving the wheels (a “parallel” hybrid), or which may be used solely to charge the on-board battery pack (a “series” hybrid). In some vehicles, a single, centrally-positioned electric motor is used to power one or more of the vehicle wheels and, in some other vehicles, one or more of the wheels have an electric motor positioned at each driven wheel.

While currently proposed and existing electric vehicles are advantageous in some respects over internal-combustion engine (ICE) powered vehicles, one recognized limitation associated with such electric vehicles is their relatively short operational range. This is particularly true for electric vehicles that are not equipped with a range extender engine. One reason for this limitation is the weight and cost of the battery packs used to store electrical energy for operation of such electric vehicles. Accordingly, it would be beneficial to provide technology that improves battery performance so as to improve the operational range of electric vehicles.

Various measures of battery performance may include, but are not limited to, battery power capability, efficiency, capacity and life. Battery life is not unlimited and a number of factors that limit battery life may include, but are not limited to, the number of recharging cycles, the rate of charging, the level of charging, the temperature of the battery during use, internal mechanical and chemical instabilities; and contamination. Batteries are typically sealed to prevent leakage and/or contamination due to normal exposure to road water and other materials. However, excessive flooding of an electric vehicle may result in the battery and its enclosure being partially or completely immersed which could significantly reduce the battery life, if not destroy the battery itself.

Accordingly, a need exists to develop an immersion tolerant electrical energy storage system including a sealed battery unit and a sealed thermal management system that addresses the disadvantages associated with otherwise conventional energy storage systems.

### SUMMARY

This section provides a general summary of the disclosure, and is not a comprehensive disclosure of its full scope or all of its features.

According to one aspect of the present disclosure, an immersion tolerant electrical energy storage system for an electric vehicle is disclosed. The immersion tolerant electrical energy storage system may include a sealed battery pack configured to permit thermal management of the battery pack. To permit such thermal management in conjunction with the sealed battery pack, a sealed heat exchanger is incorporated into the energy storage system. The heat exchanger can be air-to-air, air-to-liquid, liquid-to-air, or liquid-to-liquid in configuration so as to provide the required thermal management (i.e., heating and/or cooling) of the sealed battery pack.

The immersion tolerant electrical energy storage system of the present disclosure can further include one or more of the following features in association with the sealed battery pack and the sealed heat exchanger: A) one or more sealed external thermal management loop operable to facilitate heat transfer; B) one or more moisture and/or contamination sensing devices; C) one or more desiccant devices for condensation mitigation; D) one or more high over-pressure burst relief devices; E) a multi-piece battery enclosure with sealing mechanisms; F) a pressure venting device with an optional flame arrestor; G) an internal heating unit; H) a sealed gas fill port for providing an inert gas option; I) a pressure sensor; J) a sealed manual disconnect device and a sealed removeable manual safety/service disconnect device; K) sealed control wiring and high power wiring; L) an automatic safety disconnect device; M) an internal battery management system; N) a charger; and O) one or more sealed internal thermal management loops disposed between the sealed heat exchanger and the external thermal management loops. These features, devices, components and subsystems can be integrated individually or in any combination thereof into the immersion tolerant electrical energy storage system of the present disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The present disclosure will now be described, by way of example only, with reference to the attached drawings, in which:

FIG. 1 is a perspective view of an electric vehicle that includes an immersion tolerant electrical energy storage system in accordance with the teachings of the present disclosure;

FIG. 2 is a schematic illustration of the electric vehicle shown in FIG. 1 with the immersion tolerant electrical energy storage system of the present disclosure; and

FIG. 3 is a diagrammatic illustration of the immersion tolerant electrical energy storage system of the present disclosure showing its general arrangement and features.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the following description, the terms “battery” and “cell” may be used interchangeably and may refer to any variety of different rechargeable cell chemistries and configurations including, but not limited to lithium-ion (e.g., lithium iron phosphate, lithium cobalt oxide, other lithium metal oxides, etc.), lithium-ion polymer, nickel metal hydride, nickel cadmium, nickel hydrogen, nickel zinc, silver zinc, or other battery types/configurations adaptable for use with an electric vehicle propulsion system. The term “battery pack” as used herein refers to multiple individual batteries contained within a two-piece or multi-piece housing, the individual batteries being electrically interconnected to achieve the desired voltage and capacity for a particular electric vehicle application.

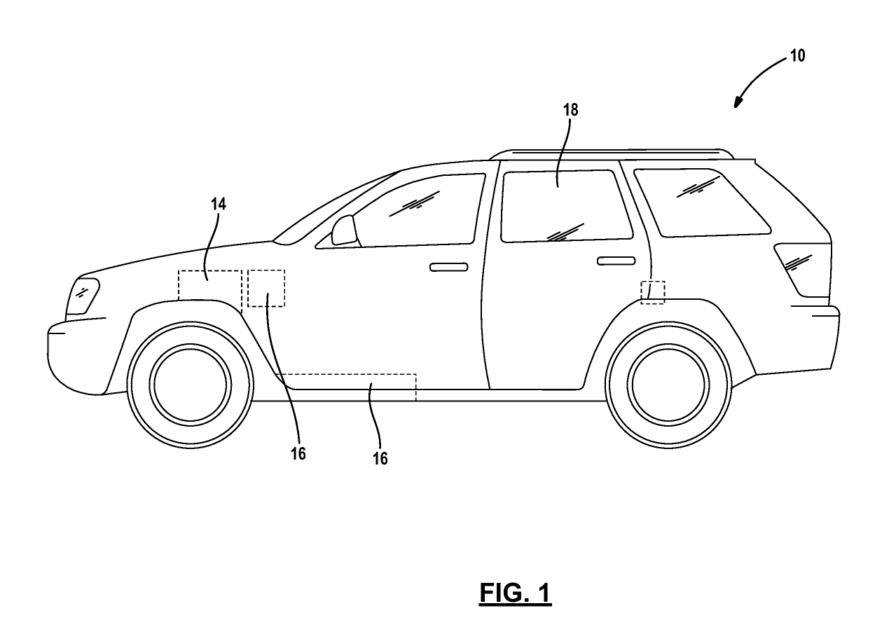

Reference is made to FIG. 1 which shows a perspective view of an electric vehicle 10 including a pair of driven wheels 12, a pair of non-driven wheels 13, an electric motor 14 for driving wheels 12, one or more battery packs 16, and a passenger cabin 18. Electric motor 14 may have any suitable configuration for use in powering electric vehicle 10. Motor 14 may be mounted in a motor compartment forward of passenger cabin 18 and that is generally in the same place as an engine compartment for a convention internal combustion engine powered vehicle. Those skilled in the art will recognize that the specific arrangement shown in FIG. 1 of electric vehicle 10 is not intended to be limiting. In particular, the teachings of the present disclosure hereinafter disclosed are contemplated to be applicable to any electric vehicle having at least one electric motor and at least one battery pack.

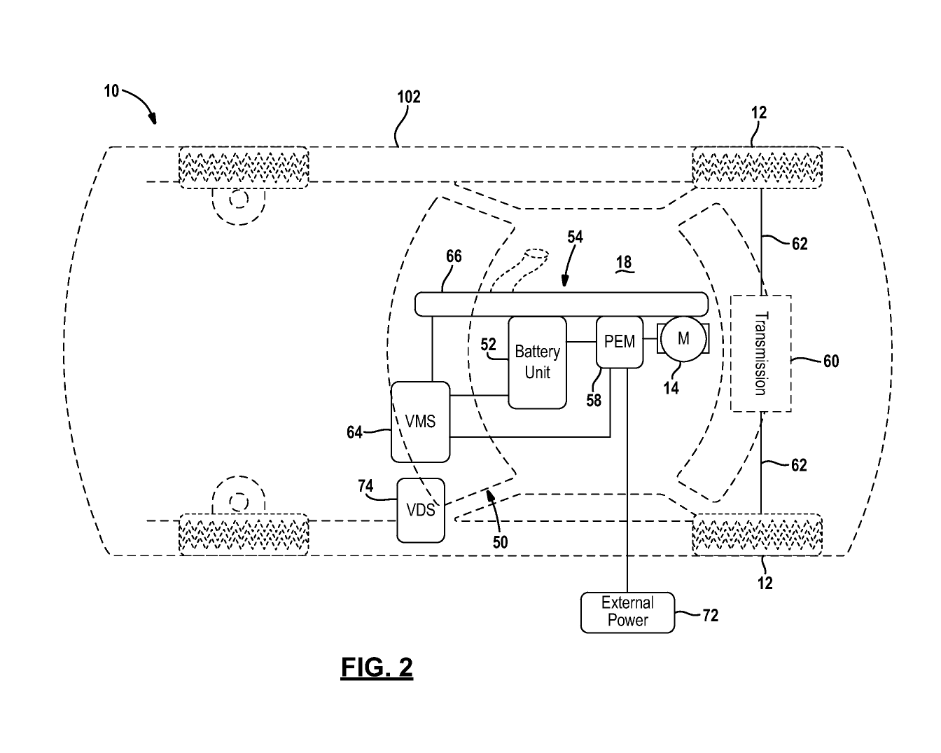

Referring now to FIG. 2, an electric vehicle propulsion system 50 is schematically shown to include a sealed battery unit 52 with which the one or more battery packs 16 are associated and electric motor 14 which is operable for converting battery energy into mechanical motion, such as driven rotation of wheels 12. The present disclosure includes an exemplary embodiment in which battery unit 52 is a subcomponent of an immersion tolerant energy storage system (“ESS”), generally identified by reference numeral 54. Battery unit 52 includes at least one battery pack 16 that, in turn, includes a plurality of electrically interconnected cells. While only schematically shown, ESS 54 will be understood to include various components required for transmitting energy to and from battery unit 52, including but yet not limited to various safety components, thermal management components, heating components and the like.

Electric propulsion system 50 is illustrated to further include a power electronics module or “PEM” 58 that is operable to convert energy from battery unit 52 into energy that is useable by motor 14. In certain situations, the energy flow is from motor 14 to battery unit 52 for regeneration purposes. In other situations, PEM 58 converts energy from battery unit 52 into energy useable by motor 14 to propel vehicle 10 via generation of a drive torque that is transmitted to wheels 12. Propulsion system 50 may include a transmission 60 which can simply be a differential unit or possibly include a one or two-speed gearset. Rotary motion outputted by transmission 60 is transferred to driven wheels 12 via a pair of axleshafts 62.

A vehicle management system or “VMS” 64 is provided which is configured to control one or more of battery unit 52, PEM 58 and ESS 54 in response to vehicular or driver-initiated inputs such as, state of charge, acceleration, braking and the like. While only schematically shown, VMS 64 is contemplated to include one or more controllers and related control systems adapted to control smooth operation of vehicle 10, its electric propulsion system 50 and its thermal management systems for battery unit 52 and passenger cabin 18.

Vehicle 10 is shown to include a thermal control system or “TCS” 66 that is operable to control the temperature of battery packs 16 within battery unit 52, as well as the temperature of PEM 58 and electric motor 14. TCS 64 can optionally be used to cool or heat cabin 18 of vehicle 10 via one or more air ducts 70. As will be detailed, TCS 64 is operably associated with ESS 54 and can further include one or more heat exchangers that circulate a medium (air or fluid) to cool one or more of the powertrain components associated with vehicle 10. An external power source 72 is shown associated with PEM 58 for converting energy from external power source 72 into energy that can be stored by battery packs 16 in battery unit 52. In one example, external power source 72 can include a charging station. As an alternative, external power source 72 can be configured to directly charge battery unit 52. Additionally, vehicle 10 includes a visual display system or VDS 74 which provides visual displays and/or visual indicators to the driver of the vehicle 10.

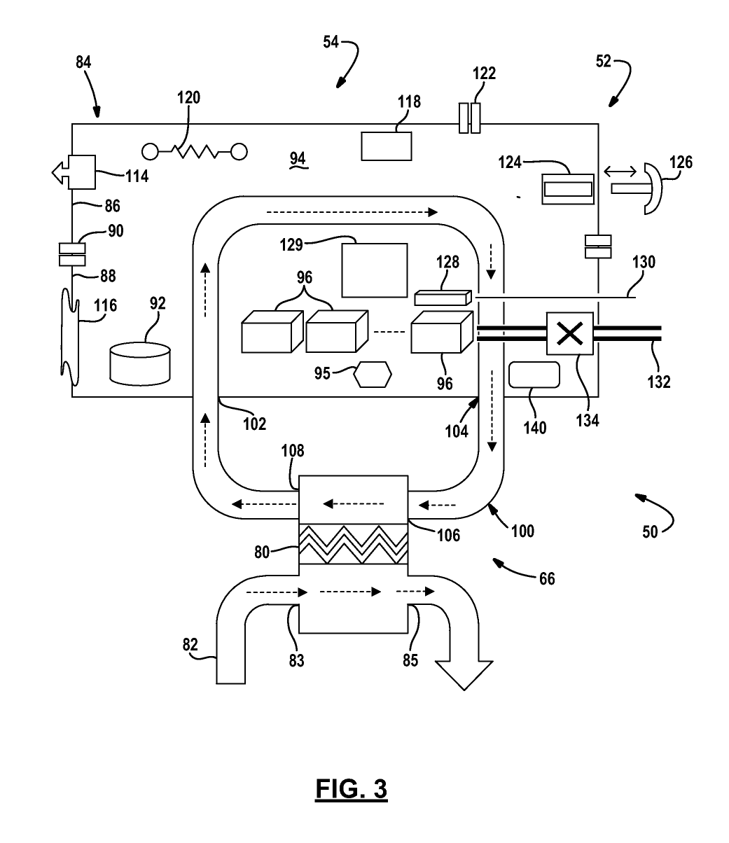

Referring now to FIG. 3, a schematic illustration of the immersion tolerant ESS 54 is provided. The term “immersion tolerant” is used herein to describe ESS 54 as being configured and arranged to inhibit the intrusion of fluids and contaminants into battery unit 52 and components of TCS 66 due to vehicle 10 being flooded or otherwise immersed. As will be appreciated, such immersion of electric vehicle 10 in water, salt water or other fluid contaminants, without such immersion tolerant features, could lead to reduced service life and/or failure of battery packs 16, electric motor 14, PEM 58 and/or the components of TCS 66.

In its most basic configuration, ESS 54 includes a sealed battery unit 52 and a sealed heat exchanger 80 that are integrated to provide a fluid-tight assembly capable of inhibiting fluid intrusion. Heat exchanger 80 can be of any suitable configuration and/or type and, for example, can be of the air-to-air type, the air-to-liquid type, the liquid-to-air type or the liquid-to-liquid type. A sealed external thermal management loop 82 is schematically shown to circulate a medium (i.e., air or fluid) through a portion of heat exchanger 80. A sealed inlet tube 83 and a sealed outlet tube 85 are associated with heat exchanger 80. While not shown, a closed circuit including some type of pumping apparatus is provided in association with external thermal management loop 82 to provide circulation of the heat exchange medium therein.

Battery unit 52 is shown to include a housing or enclosure 84 having a first housing portion 86 and a second housing portion 88 that are interconnected to define a closed enclosure 84 having an internal chamber 94. A seal member or assembly 90 is disposed between facing edge surfaces of the first and second housing portions to provide a fluid-tight interface therebetween. It is contemplated that enclosure 84 can be optimally configured to include three or more interconnected housing portions.

To provide condensation protection, one or more containers of a desiccant material 92 can be disposed within internal chamber 94 of enclosure 84 and be arranged and configured to absorb/adsorb condensation that may form therein. Additionally, a moisture sensor 95 may be disposed in chamber 94 and provide a signal indicative of a moisture level to VMS 64. Thus, desiccant canisters 92 and moisture sensor 95 function to actively assist in the removal of water vapor and are selected based on the volume of chamber 94 and the expected life of battery unit 52. A plurality of exemplary energy storage device, such as a plurality of interconnected battery cells 96 associated with battery packs 16, are shown disposed in chamber 94 of sealed enclosure 84.

In order to protect battery cells 96 from contaminants, all connections to internal chamber 94 must be hermetically sealed. To this end, a sealed internal thermal management loop 100 is shown to extend between chamber 94 and heat exchanger 80. A coolant medium (air or fluid) is circulated through sealed internal thermal management loop 100. Loop 100 may include an inlet 102 and an outlet 104 that are sealed relative to enclosure 84 as well as to heat exchanger inlet 106 and outlet 108. All of these “sealed” connections can include sealed coolant lines or hoses used to actively transfer heat from chamber 94 that is generated by battery cells 96. While not shown, sealed thermal management loop 100 includes a pumping arrangement to circulate the coolant medium therethrough.

In association with ESS 54, a pressure management system is used to ensure that the pressure differential between internal chamber 94 and the ambient environment is maintained within a predefined range. The pressure management system may include a pressure relief device 114 and/or one or more high-pressure burst relief devices 116 associated with enclosure 84. A pressure sensor 118 can also be used to detect the pressure inside enclosure 84 and send a pressure signal to VMS 64. The pressure signal can be used to actively control operation of an electrically-controlled pressure relief device 114 or any other pressure relief valves associated with battery unit 52. As an option, relief devices 114 can be two-way valves operable to ensure that the pressure differential between internal chamber 94 of sealed enclosure 84 and the outside environment does not become excessive to a point capable of causing structural damage to enclosure 84 and/or the battery cells 96 therein. Pressure differentials are caused by such things, for example, as out-gassing, battery cell venting, temperature changes and the like. To this end, burst relief devices 116 are configured and designed to expand and offset increased pressure within chamber 94 and/or fracture in a controlled manner to permit pressure relief prior to a failure of battery unit 52. As an option, pressure vent devices 114 may include flame arrestors.

With continued reference to FIG. 3, battery unit 52 is further shown to include a heating device 120 under the control of VMS 64 and which is positioned and operable to heat battery cells 96 during cold weather conditions or eliminate condensation for improved battery performance. A gas fill port 122 is also provided in association with sealed enclosure 84 and is operable to permit withdrawal of internal gases/air during or after assembly. In addition, gas fill port 122 permits injection of air of inert gases or thermally conductive gases into sealed chamber 94 if desired to improve the heat transfer characteristics. Gas fill port 122 can also be used to facilitate “leakdown” or lost pressure tests within sealed chamber 94, particularly in applications where pressure sensor 118 is not used or is malfunctioning. Such leak tests require a pressurized gas to be injected through fill port 122 and maintained in chamber 94 while enclosure 84 is checked for pressure leaks. Battery unit 52 may further include a sealed manual disconnect device 124 and a corresponding removeable manual safety/service disconnect member 126. A non-flammable sealed interconnect unit 128 is associated with battery cells 96 and is connected to VMS 64 via a sealed control wiring 130. A battery management system or BMS 129 is also associated with battery unit 52. BMS 129 is an electronic monitoring system capable of managing temperature and state of charge for each battery cell 96. High power wiring 132 for delivering electrical energy to or from battery cells 96 is likewise sealed relative to enclosure 84 and has an automatic disconnect 134 associated therewith.

While not specifically shown, multi-piece enclosure 84 is adapted to be mounted to the vehicle via one or more support trays and or structural components sized to locate and handle the weight of battery unit 52 and its subcomponents. Also not shown but associated with battery unit 52 are the fasteners, adhesives, clamp and sealing members used to provide the fluid tight seal interfaces between all components located inside or outside enclosure 84 and that have related components or structure extending therethrough. A charger 140 is provided that is operable to convert the off-vehicle AC source from the electrical grid to the DC voltage required by the battery to charge and maintain its fill state or charge.

In order to reduce the severity of and or to reduce the potential for thermal events within the Immersion Battery Pack 52, the oxygen content of the gaseous atmosphere within the pack is lowered by means of purging the interior with an inert gas, and retaining that gas within the interior of the pack at a slight positive pressure. Also, in order to improve heat transfer characteristics within the battery pack, inert gas with enhanced thermal conduction properties is introduced and retained within the pack. The inert purge gas may be nitrogen, carbon dioxide, other inert gases, and or inert gases with increased thermal conductivity.

The inert purge gas is introduced into the battery pack 52 at the Inert Gas Fill Valve 122, and vented to atmosphere through the open Purge Vent Valve 114. Purging is continued until the volume of purge gas that enters and flows through the battery pack sufficiently reduces the oxygen content within the pack. The Purge Vent Valve 114 is then closed, and the introduction of the purge gas continues until the pressure within the battery pack 52 is slightly above atmospheric pressure. The Inert Gas Fill Valve 122 is then closed, and a slight positive pressure is maintained within the battery pack 52.

The Inert Gas Fill Valve 122 is of a simple configuration, such as a Schrader valve, self-closing as the fill delivery device is disconnected. The Purge Vent Valve 114 provides a simple open/close function, with or without provision for pressure relief, since that function is provided by other means within the battery pack system. The Inert Gas Fill Valve and the Purge Vent Valve 114 are located to facilitate effective and efficient flow-through of the inert gas. The Inert Gas Fill Valve and the Purge Vent Valve are both configured to accommodate repeated events of opening and closed, so as to facilitate service procedures that may require re-purging and fill. Materials and designs of both valves are selected to resist effects of harsh automotive environments for extended periods of time.

In summary, the present disclosure provides a sealed battery pack configured to permit integration of a sealed thermal management system. This is accomplished by incorporating a sealed heat exchanger in conjunction with the sealed battery pack so as to facilitate desired heat transfer control while maintaining a sealed environment. The sealed heat exchanger is schematically shown to be separate from the battery unit but may optionally be mounted and sealed directly with or against the enclosure. As such, the sealed inlet/outlet connections may be made directly between the enclosure and a housing portion of the heat exchanger. It is also contemplated that all or a portion of the internal thermal management loop may be located within the internal chamber of the enclosure such that only the external thermal management loop connections would extend out of the enclosure in a sealed manner. Accordingly, the sealed energy storage unit in accordance with the present disclosure is provided which enables thermal control for both system conditioning and temperature management, while inhibiting the infusion of contaminants into the energy storage device. The present disclosure, particularly as shown in FIG. 3, illustrates a combination of features and optional devices which do not necessarily need to all be provided together in the energy storage unit.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An immersion tolerant electrical energy storage system for a vehicle, the vehicle including an electric motor and a battery pack, the electrical energy storage system comprising:
an enclosure including first and second housing portions interconnected with a seal mechanism to define a sealed internal chamber within which the battery pack is disposed; and
a thermal management system for thermally managing the battery pack and including a heat exchanger, an external thermal management loop sealed relative to said heat exchanger, and an internal thermal management loop sealed relative to said heat exchanger and said enclosure.

2. The immersion tolerant electrical energy storage system of claim 1 further including a moisture sensing device disposed within said internal chamber of said enclosure and which is operable to detect a moisture content level therein.

3. The immersion tolerant electrical energy storage system of claim 1 further including a desiccant device disposed within said internal chamber of said enclosure for mitigation of condensation therein.

4. The immersion tolerant electrical energy storage system of claim 1 further comprising an over-pressure burst relief device associated with at least one of said first and second housing portions of said enclosure.

5. The immersion tolerant electrical energy storage system of claim 1 further comprising a pressure venting device associated with at least one of said first and second housing portions of said enclosure.

6. The immersion tolerant electrical energy storage system of claim 1 further comprising a pressure sensing device disposed within said internal chamber of said enclosure and which is operable to detect a pressure level therein.

7. The immersion tolerant electrical energy storage system of claim 1 further comprising a heater device disposed within said internal chamber of said enclosure.

8. The immersion tolerant electrical energy storage system of claim 1 further comprising a gas fill port associated with at least one of said first and second housing portions of said enclosure.

9. The immersion tolerant electrical energy storage system of claim 1 further comprising a pressure tolerant sealed manual safely disconnect device associated with said enclosure.

10. The immersion tolerant electrical energy storage system of claim 9 further comprising a sealed removeable manual safety/service disconnect associated with said manual disconnect device.

11. The immersion tolerant electrical energy storage system of claim 1 further comprising sealed control wiring and high power wiring extending into said internal chamber of said enclosure.

12. An immersion tolerant electrical energy storage system for a vehicle, the vehicle including an electric motor and a battery pack, the electrical energy storage system comprising:
an enclosure including first and second housing portions interconnected with a seal mechanism to define a sealed internal chamber within which the battery pack is disposed;
a thermal management system for thermally managing the battery pack and including a heat exchanger, an external thermal management loop sealed relative to said heat exchanger, and an internal thermal loop sealed relative to said heat exchanger and said enclosure;
a moisture sensing device disposed within said internal chamber of said enclosure and which is operable to detect a moisture content level therein;
a desiccant device disposed within said internal chamber of said enclosure for mitigation of condensation therein; and
an over-pressure burst relief device associated with at least one of said first and second housing portions of said enclosure.

13. The immersion tolerant electrical energy storage system of claim 12 further comprising a pressure venting device associated with at least one of said first and second housing portions of said enclosure.

14. The immersion tolerant electrical energy storage system of claim 12 further comprising a pressure sensing device disposed within said internal chamber of said enclosure and which is operable to detect a pressure level therein.

15. The immersion tolerant electrical energy storage system of claim 12 further comprising a heater device disposed within said internal chamber of said enclosure.

16. The immersion tolerant electrical energy storage system of claim 12 further comprising a gas fill port associated with at least one of said first and second housing portions of said enclosure.

17. The immersion tolerant electrical energy storage system of claim 12 further comprising a pressure tolerant sealed manual safely disconnect device associated with said enclosure.

18. The immersion tolerant electrical energy storage system of claim 17 further comprising a sealed removeable manual safety/service disconnect associated with said manual disconnect device.

19. The immersion tolerant electrical energy storage system of claim 12 further comprising sealed control wiring and high power wiring extending into said internal chamber of said enclosure.
